(19) United States
(12) Patent Application Publication
(10) Pub. No.: US 2014/0168978 A1
(43) Pub. Date: Jun. 19, 2014

(54) Full-Beam-Angle LED Bulb Structure

(71) Applicant: Wen-Sung Hu, Tainan City (TW)

(72) Inventor: Wen-Sung Hu, Tainan City (TW)

(21) Appl. No.: 13/716,267

(22) Filed: Dec. 17, 2012

(51) Int. Cl. F21V 23/00; F21V 29/00

(52) U.S. Cl. CPC F21V 23/002; F21V 29/22
USPC 362/249.02

(57) ABSTRACT

A full-beam-angle LED bulb includes a bulb holder, a bulb socket, an actuator mounted in the bulb socket, a transparent bulb shell coupled with the bulb socket, two conductive poles, and a luminosity module. A retainer is provided on the actuator. Lower ends of the conductive poles are coupled with the retainer and electrically connected to the actuator. The luminosity module is installed in the transparent bulb shell and includes an LED substrate and at least one downward-light LED on a lower end face of the LED substrate. The LED substrate can be further provided with at least one upward-light LED on an upper end face thereof which is electrically connected to downward-light LED. The LED substrate is electrically connected to upper ends of the two conductive poles. The upward-light and downward-light LEDs are respectively activated to project upward light or downward light through the transparent bulb shell.

### BACKGROUND OF THE INVENTION

1. Field of the Invention

The present invention relates to a LED bulb and, more particularly, to a LED bulb structure with a full emission angle.

2. Description of the Related Art

FIG. 1 illustrates a conventional automotive tungsten bulb 1 including a glass chimney 11, a tungsten filament 12 and two conductive poles 13 supporting the tungsten filament 12. FIG. 2 illustrates a conventional halogen bulb 2 including a glass chimney 21, a tungsten filament 22 and two conductive poles 23 supporting the tungsten filament 22. FIGS. 3 and 3-1 illustrate two conventional tungsten bulbs 3 each including a glass chimney 31, a tungsten filament 32 and two conductive poles 33 supporting the tungsten filament 32. The conventional bulbs 1, 2, 3 shown in FIGS. 1, 2, 3, and 3-1 have advantages such as light projected around 360° but disadvantages such as high heat, poor efficiency, low life cycle, and waste of energy. As the green energy policy is highly promoted in international society, many advanced countries have thus set up the utilization deadline for tungsten bulbs. Light-emitting diode (LED) bulbs thus gradually enter the replacement market of tungsten bulbs. However, bulbs based on LEDs (SMD/chip) still have some problems as follows: (1) Light out of a bulb shell is projected in a single direction (see FIG. 4A, projection light of an LED bulb 4 based on the prior art is shown). The LED bulb 4 projecting light in a single direction and installed on a floor lamp, a desk lamp or a wall lamp (FIG. 4A-1) radiates upward only (e.g., beams projected to ceilings) but contributes illumination for reading a little because only dim light reflected from an oblique bulb shell of the floor lamp or the desk lamp is projected to floors. (2) Illumination can be intensified by both upward light (direct lighting) and downward light (reflective lighting) when a tungsten light bulb radiating around 360° is designed to have a fixed focal length and integrated with a reflective bowl 41 (FIG. 4B). However, diffused lighting which comes from multiple luminous sources with respective focal lengths (FIG. 4C-1) based on manufacturers' designs, e.g., light projected from LEDs on a mace-shaped bulb (FIG. 4C), cannot be referred to as effective reflected light.

Thus, an LED bulb which has a fixed focal length and projects effective downward light as well as upward light should be taken as the target of the person skilled in the art.

### BRIEF SUMMARY OF THE INVENTION

Therefore, it is an objective of the present invention to overcome the aforementioned shortcoming and deficiency of the prior art by providing a full-beam-angle LED bulb from which downward light as effective streams of light is projected, intensifying illumination for reading. Furthermore, the LED bulb may synchronously create the same upward light and reflected downward light as an ordinary tungsten light bulb.

The full-beam-angle LED bulb of the present invention includes a bulb holder, a bulb socket mounted on an upper end of the bulb holder, an actuator, a transparent bulb shell, two poles, and a luminosity module. The actuator is mounted in the bulb socket and provided with a retainer at a top end of the actuator. The transparent bulb shell is coupled to an upper end of the bulb socket, and a chamber is formed in the transparent bulb shell. Each pole includes an upper end and a lower end and engaged with an upper portion of the retainer. The luminosity module is mounted in the chamber of the transparent bulb shell and is thoroughly spaced from an inner wall of the transparent bulb shell. The luminosity module includes a lower LED substrate and at least one downward-light LED (SMD/chip) disposed on a lower end face of the lower LED substrate. Two sides of the lower LED substrate are electrically connected to the upper ends of the two poles respectively. The downward-light LED of the luminosity module is electrically connected to the actuator. The downward-light LED can be activated to project downward light through the transparent bulb shell, and a portion of projected downward light which has been transmitted through the transparent bulb shell is reflected, inducing flash back effect in the transparent bulb shell and consequent halo for some regions unaffected by direct light.

In an embodiment, upper and lower end faces of the lower LED substrate are respectively provided with LEDs for projection of both upward light and downward light which will be reflected from the transparent bulb shell and facilitate flash back effect and halo at regions with no direct light.

In a preferred form, the two poles are two conductive poles, and each conductive pole includes a lower end and an upper end. The lower end of each conductive pole is electrically connected to the actuator, and the upper end of each conductive pole is electrically connected to the lower LED substrate. In another preferred form, the actuator is electrically connected with the luminosity module by conductive filaments.

In a preferred form, the lower LED substrate is a metal plate and has two notches in two sides thereof, with a conductive board held inside each notch. Each conductive board has a hole penetrated by an upper end of one of the two poles (conductive poles) for electric connection. Each conductive board further has a conductive interface which is electrically connected to a corresponding lower conductive interface on the lower end face of the lower LED substrate.

In a preferred form, the LED bulb of the present invention further includes a heat sink body installed on the upper end face of the lower LED substrate for better cooling effect and longer life cycle of LEDs. The heat sink body can be further provided with an upper LED substrate (aluminum substrate) on an upper end face of the heat sink body and at least one upward-light LED on the upper LED substrate to generate upward and downward high-intensity radiations.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a schematic view of a conventional automotive tungsten bulb.

FIG. 2 is a schematic view of a conventional halogen bulb.

FIG. 3 is a schematic view of a conventional tungsten bulb.

FIG. 3-1 is a schematic view of another conventional tungsten bulb.

FIG. 4A is a view of projection beams of a convention LED bulb.

FIG. 4A-1 is a schematic view of the LED bulb of FIG. 4A used in a floor lamp.

FIG. 4B is a schematic view of a convention tungsten bulb with a reflective bowl installed for projection of light.

FIG. 4C is a schematic view of a mace-shaped LED bulb.

FIG. 4C-1 is a schematic view of the mace-shaped LED bulb of FIG. 4C with a reflective bowl installed for projection of light.

FIG. 5 is a cross sectional view of a LED bulb according to a first embodiment of the present invention.

FIG. 6 is an exploded, perspective view of the LED bulb of FIG. 5.

FIG. 7 is a bottom plan view of a luminosity module and two poles of the LED bulb of FIG. 5.

FIG. 8 is a top plan view of the luminosity module and the poles of the LED bulb of FIG. 5.

FIG. 9 is a cross sectional view of a LED bulb according to a second embodiment of the present invention.

FIG. 10 is a bottom plan view of a luminosity module and two poles of the LED bulb of FIG. 9.

FIG. 11 is a top plan view of the luminosity module and the poles of the LED bulb of FIG. 9.

FIG. 12 is a cross sectional view of a LED bulb according to a third embodiment of the present invention.

FIGS. 13 and 14 show cross sectional views of two LED bulbs according to fourth and fifth embodiments of the present invention.

FIGS. 15 and 16 show cross sectional views of two LED bulbs according to sixth and seventh embodiments of the present invention.

FIGS. 17 and 18 show cross sectional views of two LED bulbs according to eighth and ninth embodiments of the present invention.

FIGS. 19 and 20 show cross sectional views of two LED bulbs according to tenth and eleventh embodiments of the present invention.

FIG. 21 is a schematic view illustrating the LED bulb of the present invention with a reflective bowl integrated.

FIGS. 22-1 and 22-2 show two schematic views illustrating the LED bulb of the present invention used in a reading lamp.

FIG. 23-1 shows a schematic view illustrating an actuator of the LED bulb of the present invention electrically connected to the luminosity module by conductive filaments.

FIG. 23-2 shows another schematic view illustrating an actuator of the LED bulb of the present invention electrically connected to the luminosity module by conductive filaments.

### DETAILED DESCRIPTION OF THE INVENTION

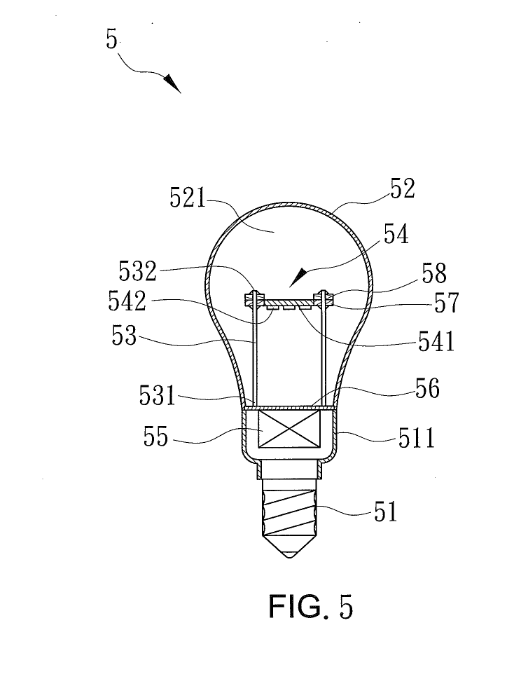

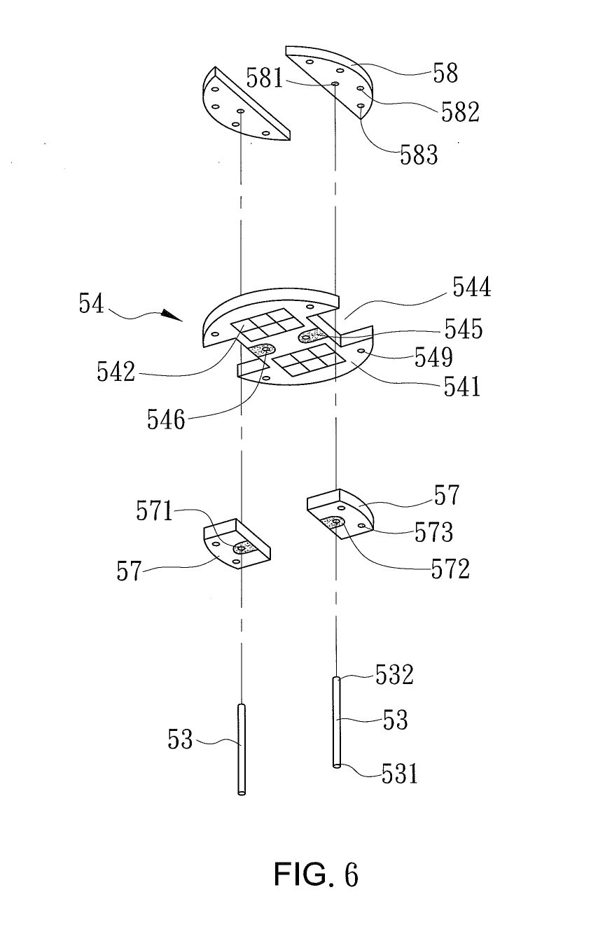

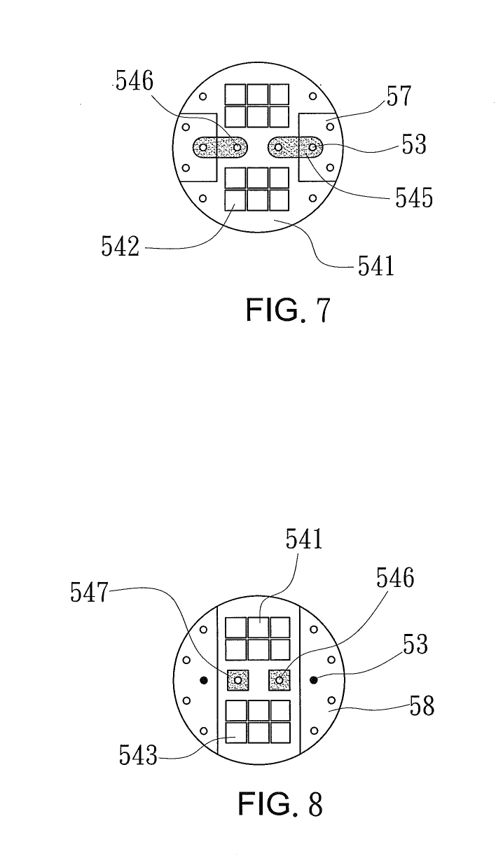

A full-beam-angle LED bulb of a first embodiment of the present invention is shown in FIGS. 5 through 8 of the drawings and generally designated 5. The LED bulb 5 includes a bulb holder 51, a transparent bulb shell 52, two poles 53, and a luminosity module 54. In this embodiment, a bulb socket 511 is mounted on an upper end of the bulb holder 51, and an actuator 55 is mounted in the bulb socket 511. A retainer 56 is provided on a top end of the actuator 55 and located at a top opening of the bulb socket 511. The transparent bulb shell 52 is constructed in a receptacle shape and coupled to an upper end of the bulb socket 511 to seal the top opening of the bulb socket 511 for development of an airtight chamber 521 inside the transparent bulb shell 52. In this embodiment, each pole 53 is a conductive pole and includes a lower end 531 and an upper end 532. The lower ends 531 of the poles 53 are engaged with an upper portion of the retainer 56 and electrically connected to the actuator 55.

The luminosity module 54 is mounted and left floating in the chamber 521 of the transparent bulb shell 52. Specifically, upper and lower faces and outer periphery of the luminosity module 54 are totally spaced from an inner wall of the transparent bulb shell 52. The luminosity module 54 includes a lower LED substrate (an aluminum substrate) 541 and at least one downward-light LED 542 disposed on a lower end face of the lower LED substrate 541. In this embodiment, the luminosity module 54 includes a plurality of downward-light LEDs (SMD/chip) 542. The lower LED substrate 541 is designed to have two notches 544 in two sides thereof, and an independent conductive board 57, such as conductive PCB (printed circuit board), is held inside each notch 544. Each conductive board 57 is provided with a hole 571 which is penetrated by an upper end 532 of one of the two poles 53 for electric connection. The conductive board 57 is further provided with a conductive interface 572 which is electrically connected to a corresponding lower conductive interface 545 on the lower end face of the lower LED substrate 541 and near the notch 544. The lower LED substrate 541 is provided with conductive holes 546 penetrating the lower conductive interfaces 545 for electric connection based on positive and negative charges of the downward-light LEDs 542 via the conductive holes 546, allowing electric connection between the downward-light LED 542 and the poles 53 via the two conductive boards 57. In this embodiment, the lower LED substrate 541 is provided with two PCB holders 58 at both sides thereof, and each PCB holder 58 is drilled to form a connecting hole 581 penetrated by the upper end 532 of one of the two conductive poles 53 for connection. The two PCB holders 58 are used to securely hold the conductive boards 57 in the two notches 544 of the lower LED substrate 541, allowing the lower LED substrate 541 and the two poles 53 to be assembled/disassembled for maintenance/replacement of the luminosity module 54. In this embodiment, each of the two PCB holders 58 is provided with a through hole 582, 583 which respectively corresponds to a through hole 573 on the conductive PCB 57 and a through hole 549 on the lower LED substrate 541 for connection.

With the conductive boards 57 of the LED bulb 5 electrically connected to the conductive poles 53, the downward-light LEDs 542 of the luminosity module 54 are electrically connected to the actuator 55 and can be controlled to radiate. Streams of light radiated from the downward-light LEDs 542 are transmitted via the transparent bulb shell 52 and become downward light.

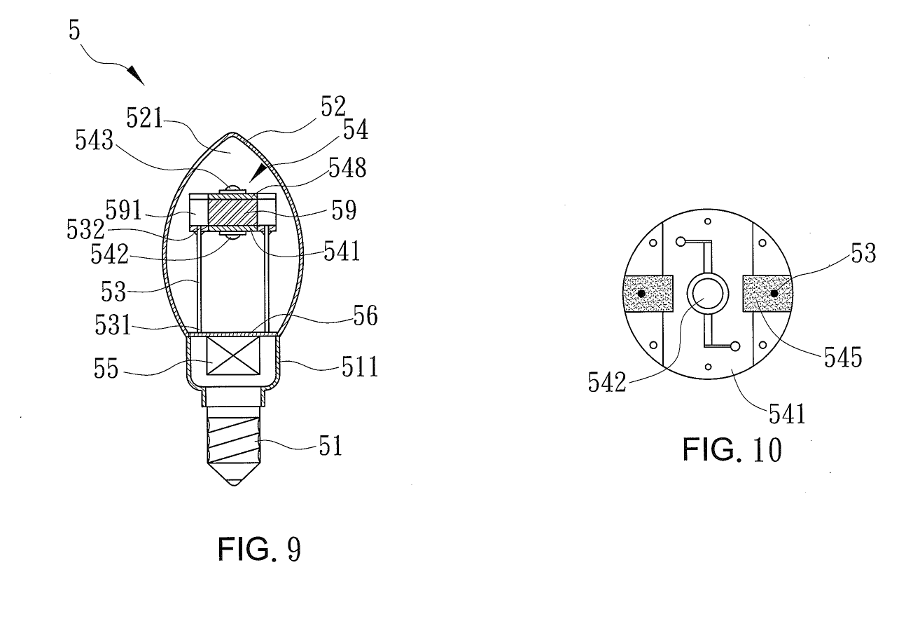

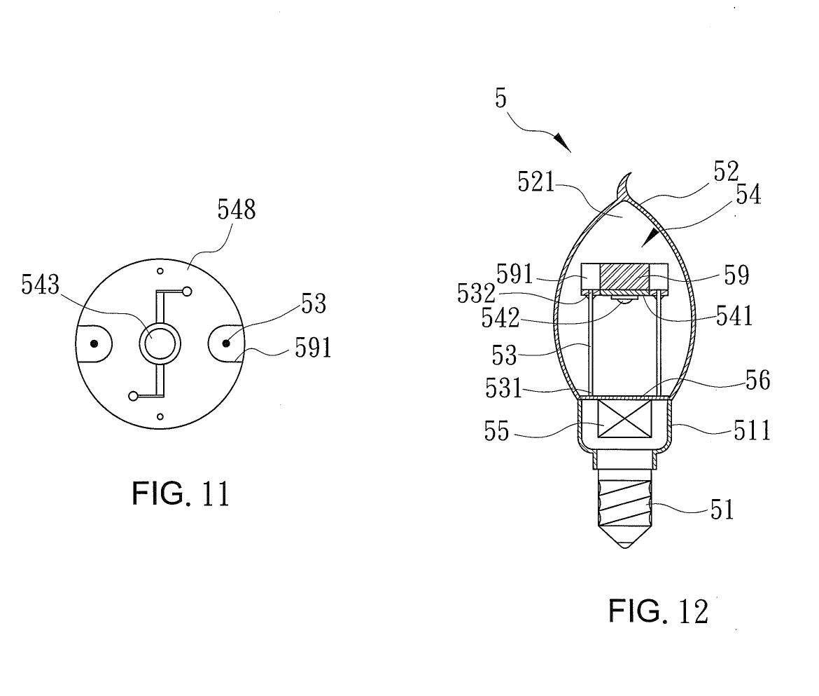

FIGS. 9 through 11 show a LED bulb 5 of a second preferred embodiment of the present invention modified from the first embodiment. Description of the parts of the LED bulb 5 shown in FIG. 9 identical to those shown in FIG. 5 is omitted. In particular, the luminosity module 54 further includes a heat sink body 59 disposed on an upper end face of the lower LED substrate 541. An upper LED substrate 548 (metal aluminum plate) is provided on an upper surface of the heat sink body 59, and at least one upward-light LED 543 is provided on the upper end face of the upper LED substrate 548. Accordingly, heat from the downward-light LEDs 542 and the upward-light LED 543 of the luminosity module 54 is dissipated outward through the heat sink body 59 for better cooling effect. Further, the heat sink body 59 is designed to have nicks 591 on its both sides which correspond to the upper ends 532 of the conductive poles 53 and separate the upper ends 532 from the heat sink body 59.

FIG. 12 shows a LED bulb 5 of a third preferred embodiment of the present invention modified from the second embodiment. In this embodiment, the upper surface of the heat sink body 59 is not provided with the upper LED substrate 548 and the upward-light LED 543. In the LED bulb 5 with the downward-light LEDs 542 mounted as unique luminous sources, effective lighting will be supplied with basic downward light radiating through the transparent bulb shell 52 only in virtue of the luminosity module 54 thoroughly spaced from the inner wall of the transparent bulb shell 52. Furthermore, flash back effect is developed in the transparent bulb shell 52 due to reflection of projected light radiating through the transparent bulb shell 52 as well as a great deal of reflected light in the transparent bulb shell 52, activating the bulb shell's some regions beyond beam angles of the downward-light LEDs 542 to generate weak transmission light and consequent halo.

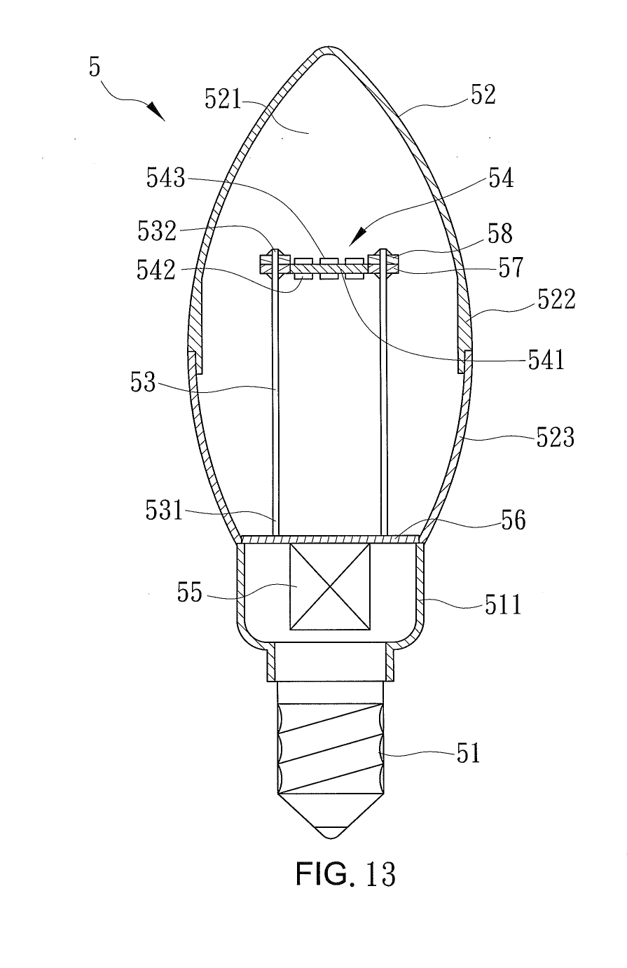

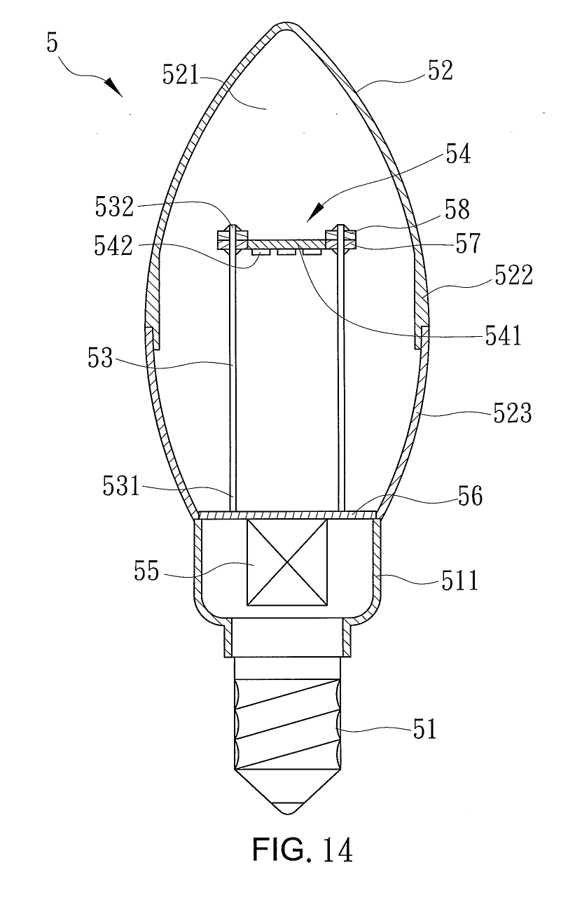

FIGS. 13 and 14 show LED bulb 5 of fourth and fifth preferred embodiments of the present invention modified from the first embodiment. In this embodiment, the transparent bulb shell 52 consists of an upper bulb shell 522 and a lower bulb shell 523. The upward-light LED 543 provided on the upper end face of the lower LED substrate 541 generates upward light which is transmitted from the upper bulb shell 522, while the downward-light LEDs 542 generate downward light which is transmitted from the lower bulb shell 522, forming full-beam-angle radiation. FIG. 14 illustrates that no upward-light LED 543 are installed on the upper end face of the lower LED substrate 541 of the luminosity module 54.

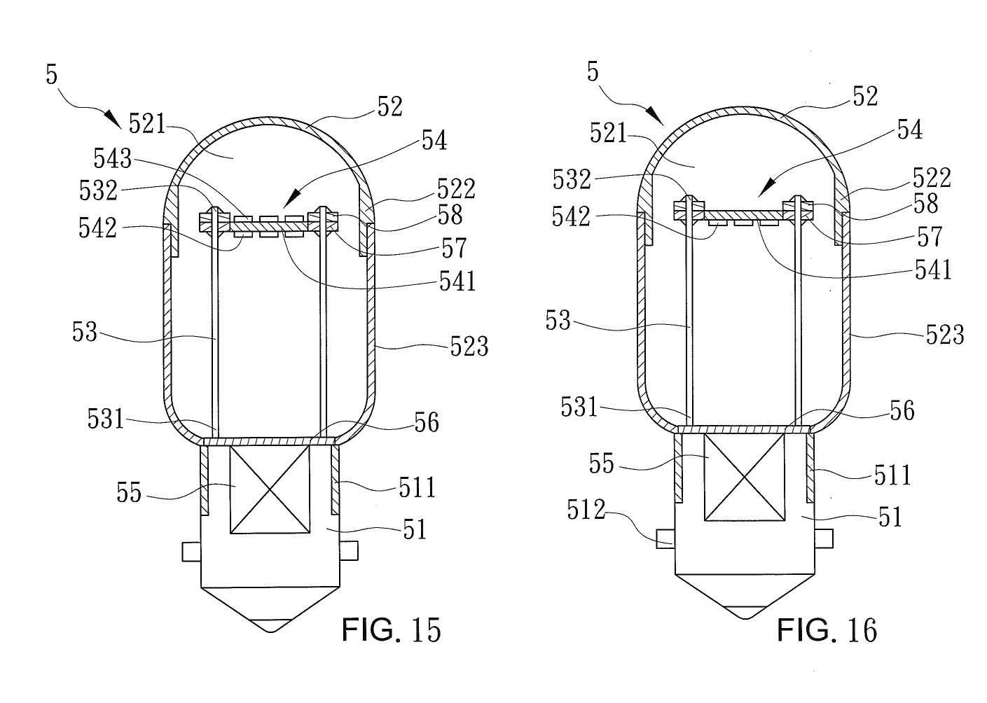

FIGS. 15 and 16 show LED bulb 5 of sixth and seventh preferred embodiments of the present invention modified from the first embodiment. In this embodiment, the transparent bulb shell 52 consists of an upper bulb shell 522 and a lower bulb shell 523. Further, the bulb holder 51 is provided with a fastener in contrast to threads on the bulb holder 51 in FIG. 5. FIG. 16 illustrates that no upward-light LED 543 shown in FIG. 15 are installed on the upper end face of the lower LED substrate 541 of the luminosity module 54.

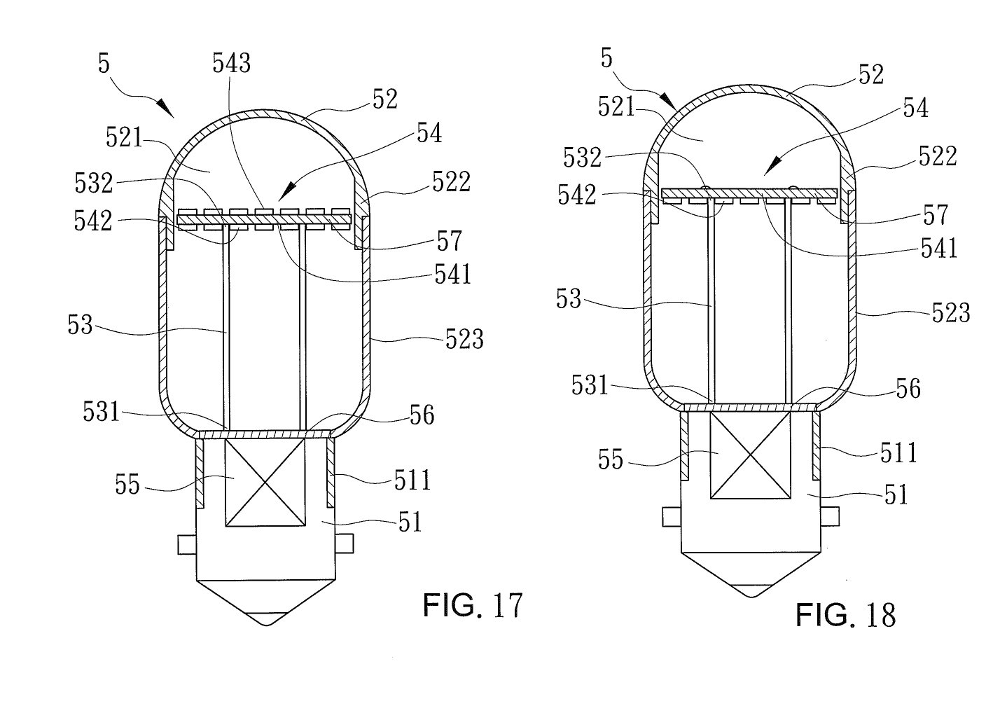

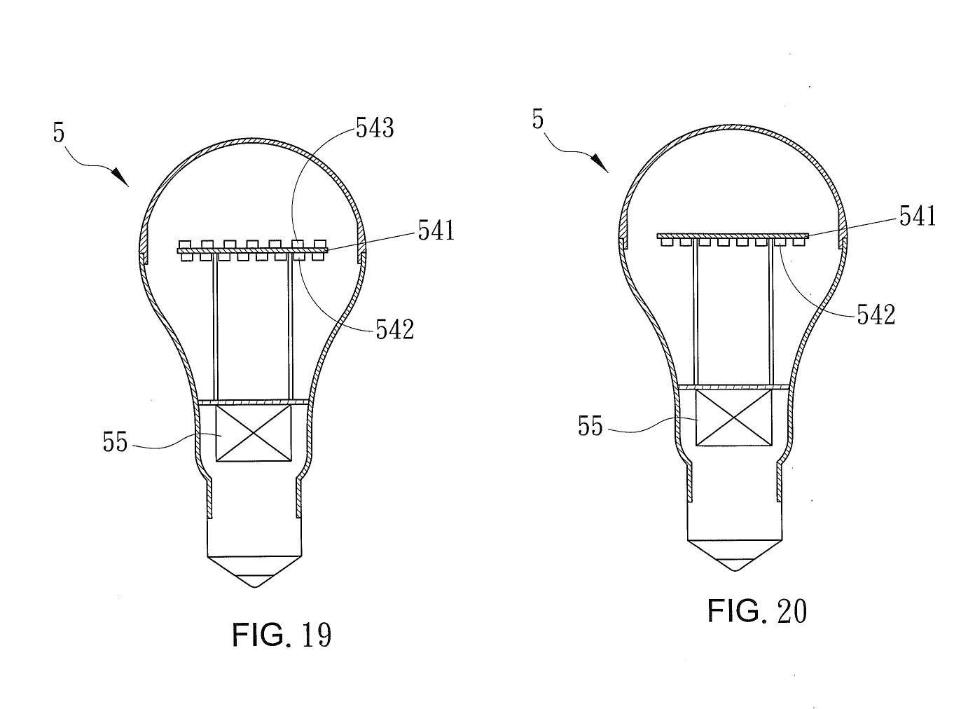

FIG. 17 through FIG. 20 illustrate an LED bulb 5 in yet other four embodiments wherein the lower LED substrate 541 of the luminosity module 54 is an PCB (printed circuit board) in contrast to the lower LED substrate 541, a metal (aluminum) substrate, of the luminosity module 54 in FIG. 15. Specifically, the downward-light LEDs 542 or the upward-light LED 543 consisting of low-lumen (low-illumination) LEDs can be supported by a PCB only which is electrically connected to the positive and negative conductive poles 53. Comparatively, the downward-light LEDs 542 or the upward-light LED 543 consisting of high-power LEDs (generating high heat) need the lower LED substrate 541 based on a metal (aluminum) substrate in order to electrically connect the conductive boards 57 corresponding to notches of the aluminum substrate with the positive and negative conductive poles 53, without any short circuit attributed to the positive and negative conductive poles 53 contacting the lower LED substrate 541. FIGS. 18 and 20 illustrate that no upward-light LED 543 shown in FIGS. 17 and 19 are installed on the upper end face of the lower LED substrate 541 of the luminosity module 54.

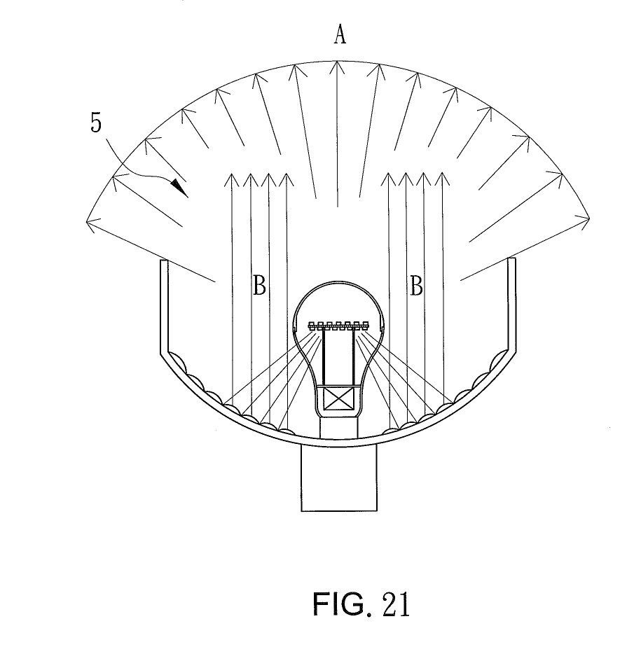

FIG. 21 illustrates the LED bulb 5 of the present invention generates the same upward light (A) and reflected downward light (B) as an ordinary tungsten light bulb mounted on one lamp for increased illumination when a reflective bowl is synchronously integrated.

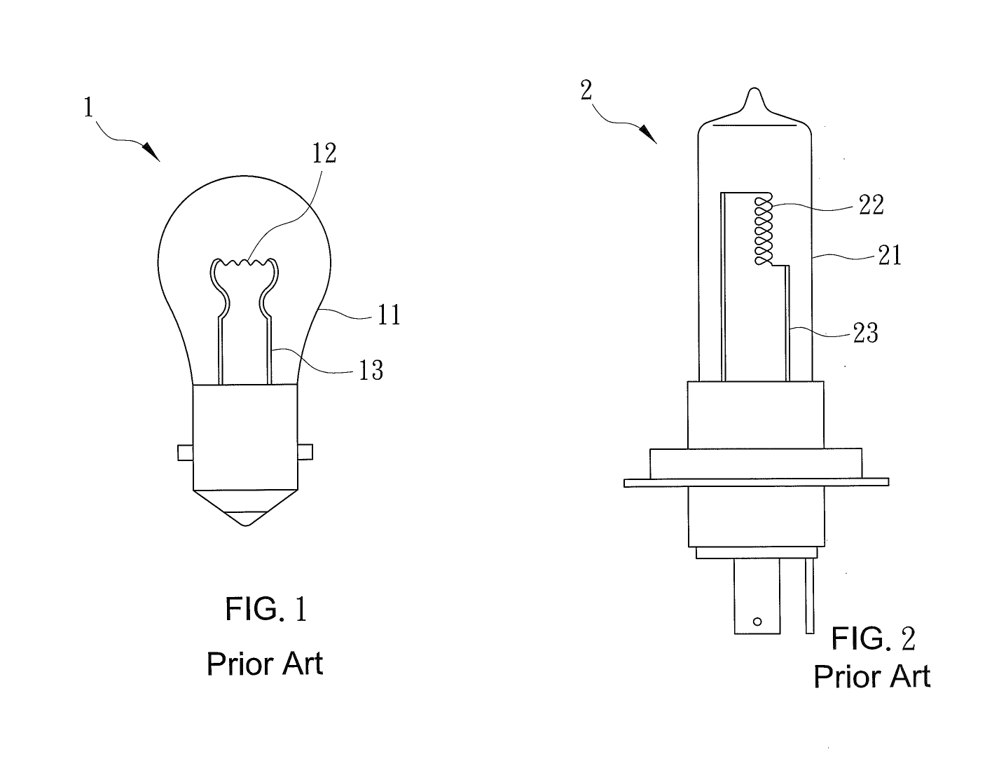

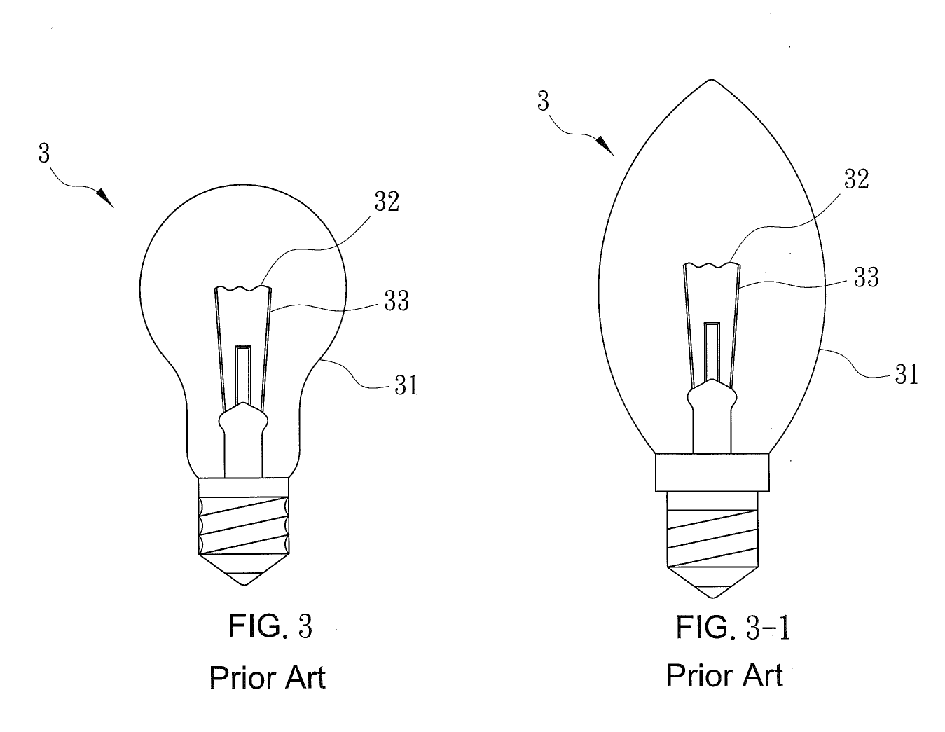

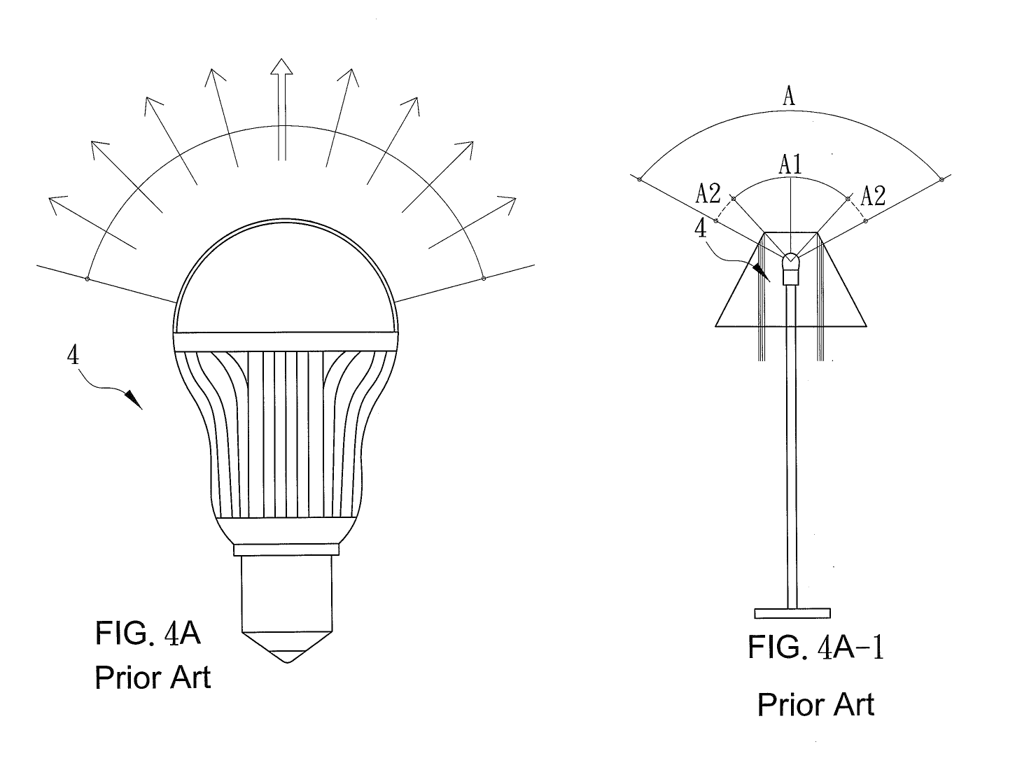

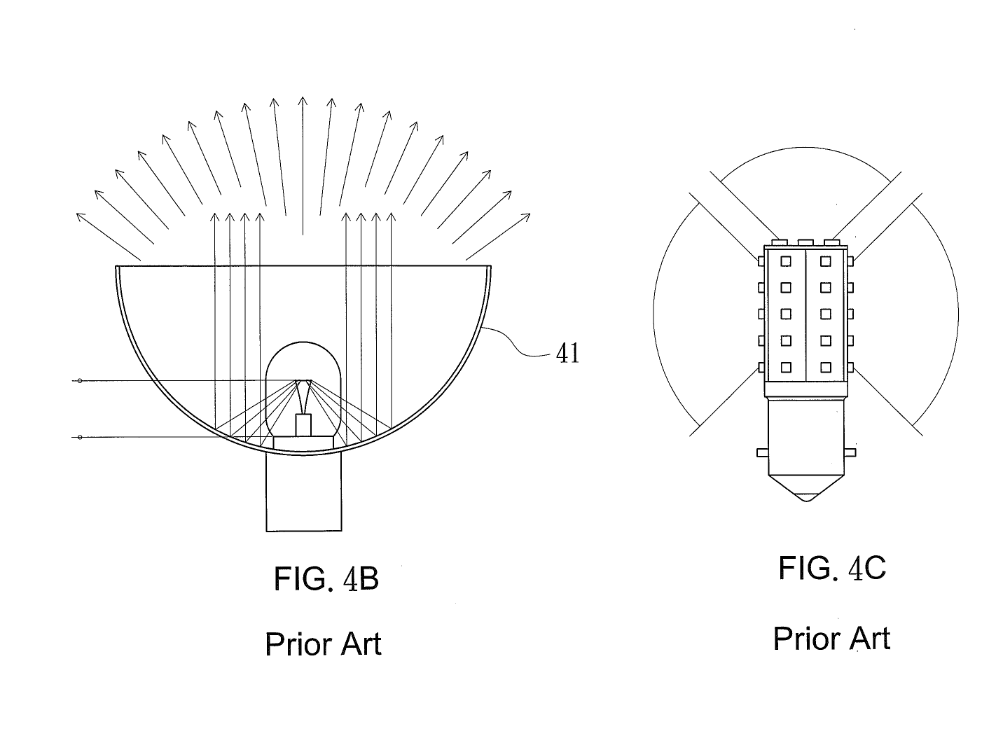

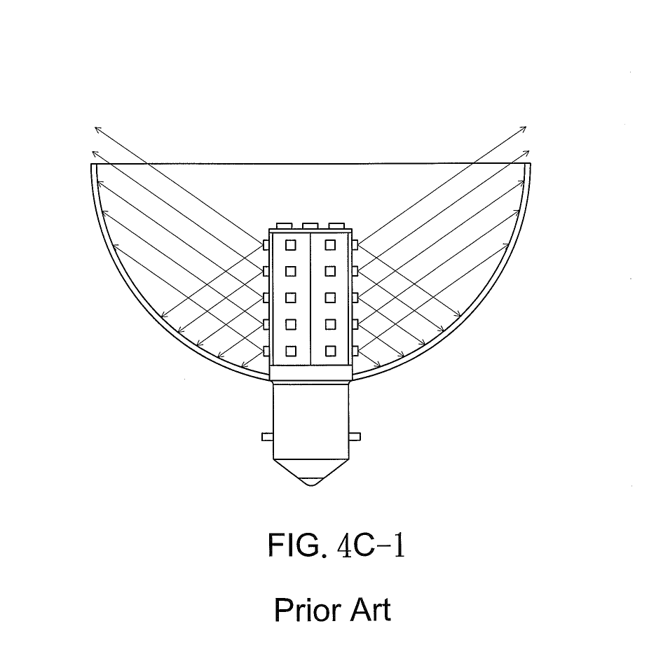

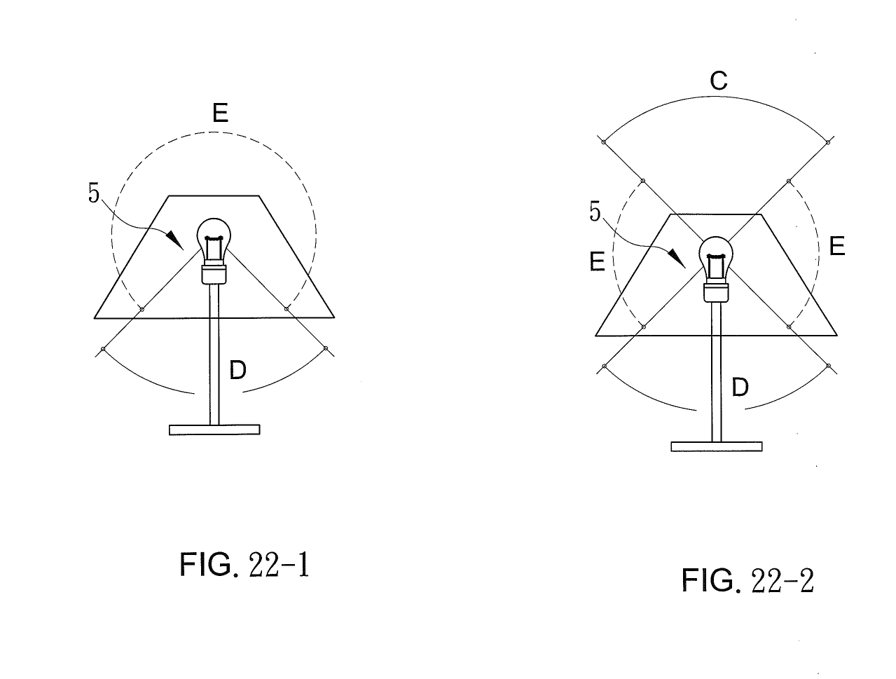

FIG. 22-1 illustrates the LED bulb 5 of the present invention which can be installed on a floor lamp, a desk lamp, a wall lamp or a bedside lamp is able to project basic downward light (D) for reading and realize halo effect (E) with other beam angles. FIG. 22-2 illustrates an LED bulb 5 with downward-light LEDs 542 and upward-light LEDs 543 which can be installed on a floor lamp, a desk lamp, a wall lamp or a bedside lamp, generating downward light (D), upward light (C) and halo effect (E), and realizing full-beam-angle effect.

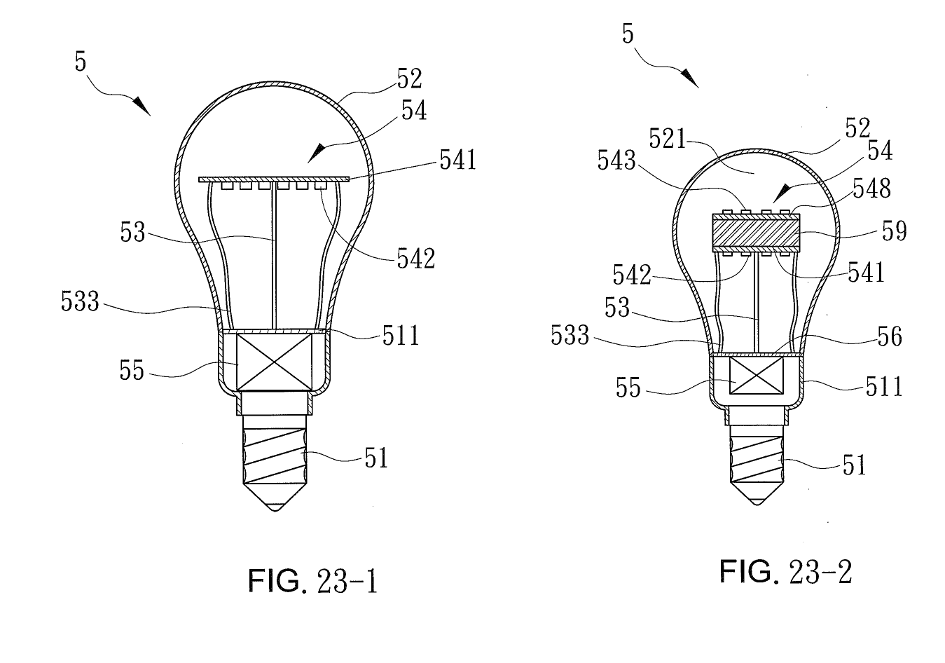

FIGS. 23-1 and 23-2 illustrate the poles 53 are nonconductive poles 53, and the actuator 55 and the lower LED substrate 541 of the luminosity module 54 are electrically connected by conductive filaments 533.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A full-beam-angle LED bulb structure comprising, in combination:
a bulb holder;
a bulb socket mounted on an upper end of the bulb holder, with an actuator mounted in the bulb socket, with a retainer provided on a top end of the actuator;
a transparent bulb shell coupled to an upper end of the bulb socket, with a chamber formed in the transparent bulb shell;
two conductive poles, with each conductive pole including a lower end and an upper end, with the lower ends of the two conductive poles engaged with the retainer and electrically connected to the actuator; and
a luminosity module mounted in the chamber of the transparent bulb shell, with upper and lower faces and an outer periphery of the luminosity module spaced from an inner wall of the transparent bulb shell, with the luminosity module including a lower LED substrate and at least one downward-light LED disposed on a lower end face of the lower LED substrate, with two sides of the lower LED substrate electrically connected to the upper ends of the two conductive poles respectively, with the at least one downward-light LED of the luminosity module electrically connected to the actuator;
wherein the at least one downward-light LED can be activated to project light beams which become downward light by transmitting the transparent bulb shell, wherein a portion of projected downward light of the at least one downward-light LED transmitted through the transparent bulb shell is reflected and induces flash back effect inside the transparent bulb shell and consequent halo beyond light angles.

2. The LED bulb structure according to claim 1, with the luminosity module further including at least one upward-light LED provided on an upper end face of the lower LED substrate.

3. The LED bulb structure according to claim 1, with the lower LED substrate being a metal plate, with a heat sink body disposed on an upper end face of the lower LED substrate.

4. The LED bulb structure according to claim 3, with the luminosity module further including an upper LED substrate and at least one upward-light LED provided on an upper end face of the upper LED substrate, with the upper LED substrate being a metal plate, with the heat sink body located between the upper and lower LED substrates.

5. The LED bulb structure according to claim 1, with the lower LED substrate being a metal plate and having two notches in the two sides thereof, with a conductive board held inside each notch and having a hole penetrated by the upper end of one of the two conductive poles for electric connection, with each conductive board further having a conductive interface which is electrically connected to a corresponding lower conductive interface on the lower end face of the lower LED substrate and near one of the notches.

6. The LED bulb structure according to claim 2, with the lower LED substrate being a metal plate and having two notches in the two sides thereof, with a conductive board held inside each notch and having a hole penetrated by the upper end of one of the two conductive poles for electric connection, with each conductive board further having a conductive interface which is electrically connected to a corresponding lower conductive interface on the lower end face of the lower LED substrate and near one of the notches.

7. The LED bulb structure according to claim 5, further comprising a heat sink body with a nick in each of two sides thereof, with the heat sink body provided on an upper end face of the lower LED substrate, with the nicks of the heat sink body corresponding to the upper ends of the two conductive poles and separating the upper ends of the two conductive poles from the heat sink body.

8. The LED bulb structure according to claim 7, with the luminosity module further including an upper LED substrate and at least one upward-light LED provided on an upper end face of the upper LED substrate, with the upper and lower LED substrates are mounted on upper and lower end faces of the heat sink body respectively.

9. The LED bulb structure according to claim 5, further comprising a holder securing the lower LED substrate with each conductive board.

10. The LED bulb structure according to claim 6, further including a holder securing the lower LED substrate with each conductive board.

11. The LED bulb structure according to claim 9, with the transparent bulb shell including an upper transparent bulb shell and a lower transparent bulb shell coupled to the upper transparent bulb shell.

12. The LED bulb structure according to claim 10, with the transparent bulb shell including an upper transparent bulb shell and a lower transparent bulb shell coupled to the upper transparent bulb shell.

13. A full-beam-angle LED bulb structure comprising, in combination:
a bulb holder;
a bulb socket mounted on an upper end of the bulb holder, with an actuator mounted in the bulb socket, with a retainer provided on a top end of the actuator;
a transparent bulb shell coupled to an upper end of the bulb socket, with a chamber formed in the transparent bulb shell;
at least one pole including a lower end and an upper end, with the lower end of the at least one pole engaged with an upper end of the retainer; and
a luminosity module mounted in the chamber of the transparent bulb shell and supported by the upper end of the at least one pole, with upper and lower faces and an outer periphery of the luminosity module spaced from an inner wall of the transparent bulb shell, with the luminosity module including a lower LED substrate and at least one downward-light LED disposed on a lower end face of the lower LED substrate, with the lower LED substrate of the luminosity module electrically connected to the actuator by conductive filaments;
wherein the at least one downward-light LED can be activated to project light beams which become downward light by transmitting the transparent bulb shell, wherein a portion of projected downward light of the at least one downward-light LED transmitted through the transparent bulb shell is reflected and induces flash back effect inside the transparent bulb shell and consequent halo beyond light angles.

14. The LED bulb structure according to claim 13, with the luminosity module further including at least one upward-light LED provided on an upper end face of the lower LED substrate.

15. The LED bulb structure according to claim 13, with the lower LED substrate being a metal plate, with a heat sink body disposed on an upper end face of the lower LED substrate.

16. The LED bulb structure according to claim 15, with the luminosity module further including an upper LED substrate and at least one upward-light LED provided on an upper end face of the upper LED substrate, with the upper LED substrate being a metal plate, with the heat sink body located between the upper and lower LED substrates.
